(19) United States
(12) Patent Application Publication
(10) Pub. No.: US 2024/0067780 A1
(43) Pub. Date: Feb. 29, 2024

(54) Pyrolysis of 2D Coordination Polymer Precursors for the Formation of ORR Active Solid Acid Fuel Cell Electrode Catalysts

(71) Applicant: The Government of the United States of America, as represented by the Secretary of the Navy, Arlington, VA (US)

(72) Inventors: James A. Ridenour, Arlington, VA (US); Olga Baturina, Burke, VA (US); Albert Epshteyn, Potomac, MD (US); Bethany Hudak, Accokeek, MD (US); Hannah Marie Ashberry, Alexandria, VA (US)

(73) Assignee: The Government of the United States of America, as represented by the Secretary of the Navy, Arlington, VA (US)

(21) Appl. No.: 18/240,088

(22) Filed: Aug. 30, 2023

Related U.S. Application Data
(60) Provisional application No. 63/374,134, filed on Aug. 31, 2022.

(51) Int. Cl. C08G 83/00

(52) U.S. Cl. CPC C08G 83/00

(57) ABSTRACT

Described herein is the preparation of solid acid fuel cell (SAFC) electrode materials suitable for intermediate temperature (200° C.-300° C.) oxygen reduction reaction (ORR) catalysis via anaerobic, in vacuo pyrolysis of metal-organic coordination polymer precursor materials with divalent metals (e.g. Pt or Pd) as nodes to form small, catalytically active nanoparticles inside a porous, electrically conductive carbonized framework.

### CROSS-REFERENCE TO RELATED APPLICATIONS

This application claims the benefit of U.S. Provisional Application No. 63/374,134 filed on Aug. 31, 2022, the entirety of which is incorporated herein by reference.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, DC 20375, USA; +1.202.767.7230; techtran@nrl.navy.mil, referencing NC 211206.

### BACKGROUND

Intermediate temperature solid acid fuel cells (i.e., those operating in the range of 200° C.-300° C.) require novel or modified electrode materials to sustain operation under the corrosive and elevated temperature environments common in SAFCs (see “Thermal Stability in Air of Pt/C Catalysts and PEM Fuel Cell Catalyst Layers.” Baturina, O. A., Aubuchon, S., Wynne, K. J., Chem. Mater: 2006, 18, 1498-1504). Traditional electrode materials for polymer electrolyte membrane (PEM) fuel cells utilize deposited Pt nanoparticles on porous graphitic or Vulcan carbon (e.g. Pt/C), yet are inappropriate for higher temperature operation due to degradation of the carbon framework. Fuel cell electrodes must be electrically conductive and porous to allow for gas mobility, and contain catalytically active sites appropriate for fuel cell relevant chemistries and carbon-based coordination polymer frameworks allow for all these aspects in a single material. Deposition of Pt nanoparticles or nanostructures into metal-organic frameworks (MOFs) or other coordination polymer materials by several different means (e.g., insipient wetness, atomic layer deposition) have been accomplished previously (see “Metal-Organic Frameworks in Heterogeneous Catalysis: Recent Progress, New Trends, and Future Perspectives.”, Bavykina A., et al., Chem. Rev., 2020, 120, 16, 8468-8535; “Metal-Organic Framework-Base Catalysts with Single Metal Sites.” Wei, Y.-S., et. al., Chem. Rev. 2020, 120, 21, 12089-12175; and “Engineering the Low Coordinated Pt Single Atom to Achieve the Superior Electrocatalytic Performance toward Oxygen Reduction.” Song, Z., et al., Small, 2020, 2003096).

A need exists for new techniques to create catalytic nanoparticles within metal-organic coordination polymers while affording control over the size distribution of the nanoparticles and the overall metal density within the carbon framework structure.

### BRIEF SUMMARY

In a first embodiment, method of preparing a porous metal-carbon framework involves mixing 2,3,6,7,10,11-hexaminotriphenylene hexahydrochloride, H₂O, NH₄OH, and a metal salt to form a metal-containing coordination polymer; and heating the coordination polymer to a temperature greater than 250° C., thereby reducing metal nodes therein, thus forming the porous metal-carbon framework.

Additional embodiments include the porous metal-carbon frameworks themselves, having been prepared according to the first embodiment.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A and 1B depict increasing size of Pt nanoparticles with increasing pyrolysis temperature.

FIGS. 2A and 2B show that platinum nanoparticles within an electrically conductive carbonized framework as described herein have catalytic activity to the oxygen reduction reaction.

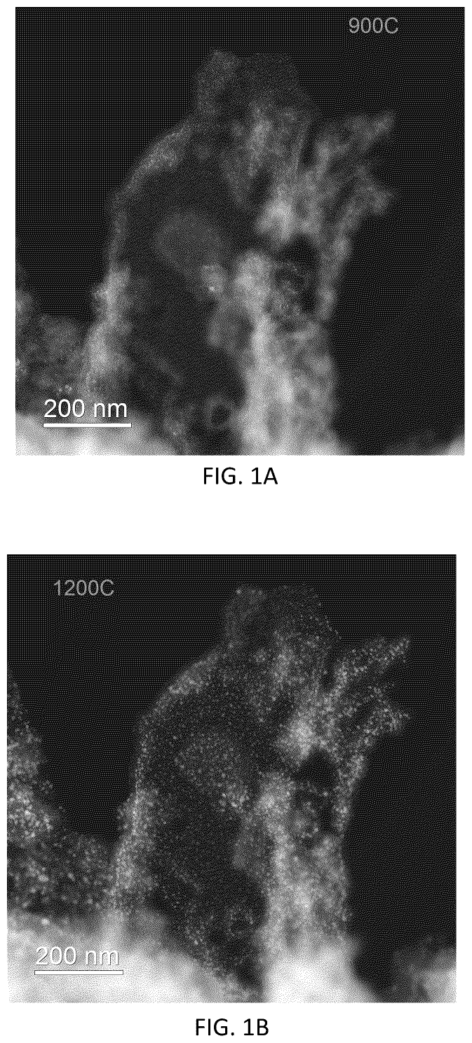

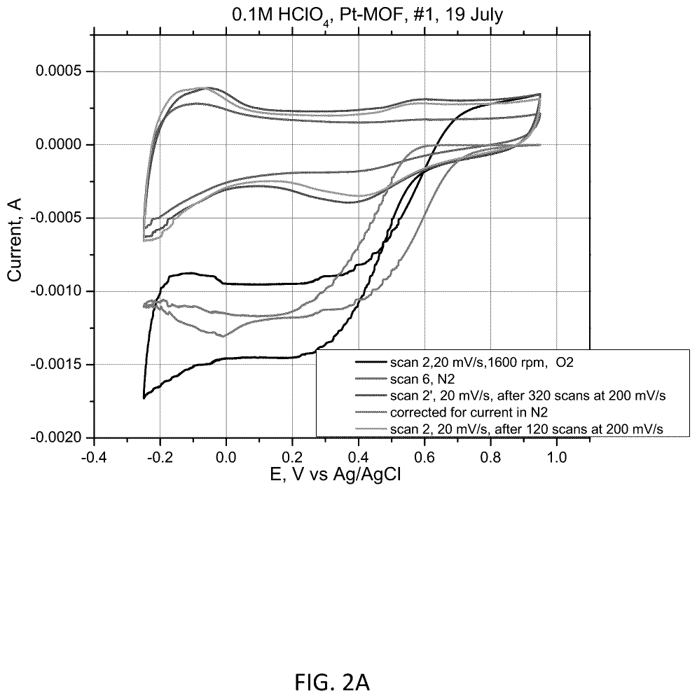

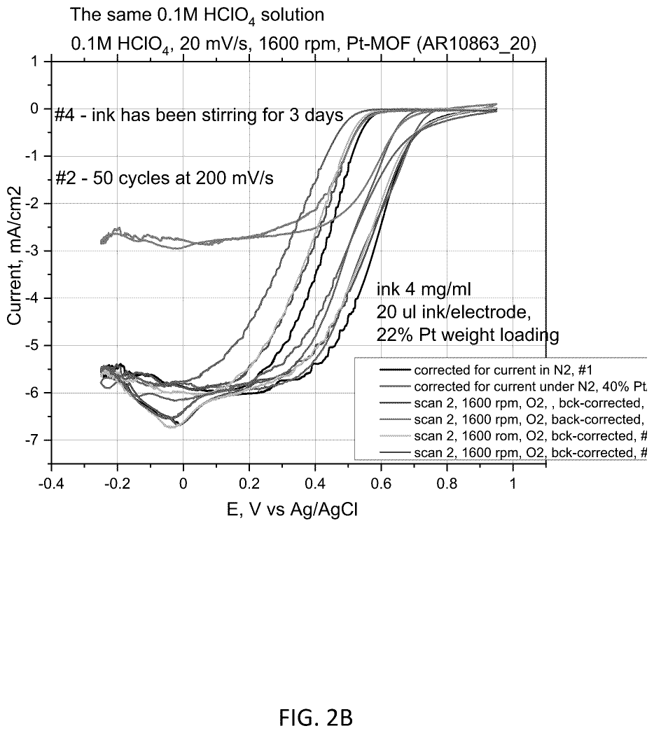

### DETAILED DESCRIPTION

### Definitions

Before describing the present invention in detail, it is to be understood that the terminology used in the specification is for the purpose of describing particular embodiments, and is not necessarily intended to be limiting. Although many methods, structures and materials similar, modified, or equivalent to those described herein can be used in the practice of the present invention without undue experimentation, the preferred methods, structures and materials are described herein. In describing and claiming the present invention, the following terminology will be used in accordance with the definitions set out below.

As used herein, the singular forms “a”, “an,” and “the” do not preclude plural referents, unless the content clearly dictates otherwise.

As used herein, the term “and/or” includes any and all combinations of one or more of the associated listed items.

As used herein, the term “about” when used in conjunction with a stated numerical value or range denotes somewhat more or somewhat less than the stated value or range, to within a range of ±10% of that stated.

Overview

Described herein is the preparation of solid acid fuel cell (SAFC) electrode materials suitable for intermediate temperature (200° C.-300° C.) oxygen reduction reaction (ORR) catalysis via anaerobic, in vacuo pyrolysis of metal-organic coordination polymer precursor materials with divalent metals (e.g. Pt or Pd) as nodes to form small, catalytically active nanoparticles inside a porous, electrically conductive carbonized framework.

The synthesis of the 2D coordination polymer precursor with various divalent metal cations and monovalent anions (e.g. PtCl₂) is achieved by suspending 3 equivalents of MX₂ (where M=Pt²⁺, Pd²⁺, Ni²⁺ and X═Cl⁻, acac⁻) salt in ˜65° C. water with stirring. Two equivalents of hexaaminetriphenylene (HATP) suspended in dilute NH₄OH is then combined with the stirring metal salt solution and is heated at −65° C. and stirred, uncovered, for 1 hour to 5 days. A black or purple solid (depending on the metal salt used) is isolated, filtered, and washed with water before being washed with acetone or methanol and dried in a vacuum oven at 75-100° C. overnight. Yields of the precursor material are above 60%. The precursor coordination polymer material is then subjected to dynamic vacuum and temperatures above 250° C. to pyrolyze the carbon framework and reduce the metal nodes to metal nanoparticles.

### Example A: Ni-Containing Carbonized Material

A solution/suspension of 0.721 g 2,3,6,7,10,11-Hexaminotriphenylene hexahydrochloride (2 equiv.), 100 mL H₂O, and 5.4 mL of concentrated NH₄OH was stirred and heated to 65° C. in a 250 mL Erlenmeyer flask before a solution/suspension of 0.492 g NiCl₂·6 H₂O (3 equiv.) and 100 mL of H₂O, also heated to 65° C., was added. This mixture was stirred for 2 hours at 65° C., uncovered, followed by filtration, then refluxed in water overnight, and then refluxed in acetone for two hours. The black solid was dried in a vacuum oven overnight. This black solid was then heated under dynamic vacuum at 300° C. for 3 hours to reduce the nickel metal nodes of the coordination polymer to nickel metal nanoparticles and generate a porous carbonized Ni/C framework.

### Example B: Pt-containing Carbonized Material

A solution/suspension of 0.612 g 2,3,6,7,10,11-Hexaminotriphenylene hexahydrochloride (2 equiv.), 75 mL H₂O, and 4.5 mL of concentrated NH₄OH were stirred and heated to 65° C. in a 250 mL Erlenmeyer flask before a solution/suspension of 0.472 g PtCl₂ (3 equiv.) and 75 mL of H₂O, also heated to 65° C., was added. This mixture was stirred for 2 hours at 65° C., uncovered, followed by filtration, washing with water, and then acetone. The black solid was dried at 85° C. in a vacuum oven overnight. The solids weighed at 0.436 g (62% yield). This black solid was then heated under dynamic vacuum at 300° C. for 3 hours to reduce the platinum metal nodes of the coordination polymer to platinum metal nanoparticles and generate a porous carbonized Pt/C framework.

### FURTHER EMBODIMENTS

It should be possible to us other sources of divalent metal cations other than chloride, including acetate or acetylacetonates salts, and likely any other divalent metal salt with sufficiently labile ligands, can be utilized to prepare the precursor metal-organic coordination polymer materials described above. These sources may consist of, but are not limited to, such compounds as other halides salts, and other monovalent anion metal salts.

Furthermore, other divalent metal atoms can be paired with the hexaaminetriphenylene ligand to generate precursor 2D coordination polymer materials that similarly can be pyrolyzed to precipitate the reductive nanoparticle formation. These can include, by way of nonlimiting example, such divalent metal cations as Cu²⁺, Pd²⁺, Co²⁺, Mn²⁺, Sn²⁺, Pb²⁺, Zn²⁺ and others known in the art.

Starting materials, particularity the metal salts, do not need to be highly soluble in the solvent; the reactions appear to proceed even when reagents are only sparingly soluble in water or dilute ammonium hydroxide (reaction solution). Mixed metal cation sources may also be possible (using both e.g. NiCl₂ and PtCl₂), resulting in mixed-phase precursor materials and thus mixed-phase nanomaterials on carbonized frameworks.

### Advantages

This methodology, involving pyrolyzing a polymer to achieve catalytic nanoparticles in a conducting, porous, carbon framework, represents a significant improvement in the formation of porous carbonized frameworks with homogeneously dispersed catalytically and electrocatalytically active composites. Not only does the framework precursor material allow for the even and regular distribution of metal centers, but the amine moieties of the organic linker also facilitate the reduction of the metal nodes to small, precious-metal nanoparticles upon anaerobic pyrolysis, evenly dispersing the catalyst throughout the now-carbonized framework. The nanoparticles size and shape can be controlled to between 1 nm and 100 nm depending on pyrolysis temperature and length of time. The pyrolysis process occurs under dynamic vacuum and has been demonstrated in smaller amounts (<100 mg) or in greater (>1 g) to create nano-Pt particles that are embedded in carbonized frameworks with Pt loadings between 20% and 40%. These porous frameworks were then found to be capable of efficient ORR catalysis under acidic conditions, making them promising for fuel cell or electrolyzer operation, among other uses.

### CONCLUDING REMARKS

All documents mentioned herein are hereby incorporated by reference for the purpose of disclosing and describing the particular materials and methodologies for which the document was cited.

Although the present invention has been described in connection with preferred embodiments thereof, it will be appreciated by those skilled in the art that additions, deletions, modifications, and substitutions not specifically described may be made without departing from the spirit and scope of the invention. Terminology used herein should not be construed as being “means-plus-function” language unless the term “means” is expressly used in association therewith.

What is claimed is:

1. A method of preparing a porous metal-carbon framework, the method comprising:
mixing 2,3,6,7,10,11-hexaminotriphenylene hexahydrochloride, H₂O, NH₄OH, and a metal salt to form a metal-containing coordination polymer;
and heating the coordination polymer to a temperature greater than 250° C., thereby reducing metal nodes therein, thus forming the porous metal-carbon framework.

2. The method of claim 1, wherein said metal is Pt or Ni.

3. The method of claim 1, wherein said metal is Ni and said salt is NiCl₂.

4. The method of claim 1, wherein said metal is Pt and said salt is PtCl₂.

5. A material comprising a porous metal-carbon framework,
the framework in a state of having been formed by mixing 2,3,6,7,10,11-hexaminotriphenylene hexahydrochloride, H₂O, NH₄OH, and a metal salt to form a metal-containing coordination polymer; and heating the coordination polymer thereby reducing metal nodes therein.

6. The material of claim 5, wherein said metal is Pt or Ni
